(19) United States
(12) Patent Application Publication
(10) Pub. No.: US 2025/0124588 A1
(43) Pub. Date: Apr. 17, 2025

(54) DISTANCE DETERMINATION METHOD AND DEVICE USING THE SAME

(71) Applicant: Nextchip Co., Ltd., Seongnam-si (KR)

(72) Inventor: Young Seok OH, Seoul (KR)

(73) Assignee: Nextchip Co., Ltd., Seongnam-si, KG (KR)

(21) Appl. No.: 18/911,452

(22) Filed: Oct. 10, 2024

(30) Foreign Application Priority Data
Oct. 13, 2023 (KR) 10-2023-0136774

(51) Int. Cl. G06T 7/55; G06T 7/11; G06T 7/12; G06T 7/536

(52) U.S. Cl. CPC G06T 7/55; G06T 7/11; G06T 7/12; G06T 7/536; G06T 2207/30256

(57) ABSTRACT

A distance determination method includes generating a target image using a camera, generating a lane plane image based on the target image, generating a depth map based on the target image, and determining a target distance between the camera and a point in a real world corresponding to a target pixel in the lane plane image based on the lane plane image and the depth map.

### CROSS-REFERENCE TO RELATED APPLICATION

This application claims the benefit of Korean Patent Application No. 10-2023-0136774 filed on Oct. 13, 2023, in the Korean Intellectual Property Office, the entire disclosure of which is incorporated herein by reference for all purposes.

### BACKGROUND

### 1. Field of the Invention

One or more embodiments relate to a distance determination method and, more particularly, to a method of determining the distance from an object using an image acquired by capturing a view in front of a vehicle.

### 2. Description of the Related Art

A depth map is a representation method that represents distance (depth) information of each pixel in a two-dimensional (2D) image, through which a three-dimensional (3D) scene in the real world may be represented in the form of a 2D image. In particular, a depth map for a view in front of a vehicle, as a type of advanced driver assistance systems (ADAS), is widely used to detect an object in front of a vehicle. The depth map may identify the relative distance between objects in front of a vehicle, which helps with functions such as collision avoidance or path planning.

To obtain a depth map, a light detection and ranging (LiDAR) sensor or stereo camera may be used. In this case, the sensor or camera may be installed on the outer side of a vehicle and damage the appearance of the vehicle, or less utilized depending on the performance of the device. For an object with light reflection properties such as a mirror, inaccurate information may be sensed. In addition, a depth map estimation technique using recently developed deep learning may estimate a depth map easily and quickly, but even in this case, only relative information between objects in a 2D image may be determined.

There is a need to provide a distance determination method to estimate the actual distance between a vehicle and an object and a device using the same.

### SUMMARY

The present disclosure is intended to solve the issues described above and other issues.

A distance determination method and a device using the same according to an embodiment may determine the distance to an object positioned in front of a vehicle based on an image from a camera.

However, the technical goals are not limited to those described above, and other technical goals may be present.

According to an aspect, there is provided a distance determination method including generating a target image using a camera, generating a lane plane image based on the target image, generating a depth map based on the target image, and determining a target distance between the camera and a point in a real world corresponding to a target pixel in the lane plane image based on the lane plane image and the depth map.

The generating of the lane plane image may include generating a first image in which a region of interest is set, based on the target image, generating a second image in which line segments are extracted, based on the first image, generating a third image in which lane lines are extracted, based on the second image, and generating the lane plane image, based on the third image.

The generating of the first image may include setting a vanishing point for the target image, and extracting the region of interest based on the vanishing point.

The generating of the second image may include separating line segments for the region of interest in the first image, and extracting the separated line segments.

The line segments may be separated based on edges of objects included in the region of interest.

The line segments may be separated based on a degree of changes in brightness values of pixels included in the region of interest.

The generating of the third image may include separating lane lines for the line segments in the second image, and extracting the separated lane lines.

The lane lines may be separated based on angles of lines included in the line segments, lengths of the lines included in the line segments, or distances from a vanishing point to the lines included in the line segments.

The generating of the lane plane image based on the third image may include determining a lane region based on the lane lines in the third image, and generating the lane plane image based on the determined lane region.

The lane region may be determined based on coordinate values of pixels included in the lane lines.

The generating of the depth map may include generating a depth map for the target image using a pre-trained depth map generation model.

The determining of the target distance may include determining a target pixel in the lane plane image, determining a target normal vector for the target pixel in the lane plane image, determining a relative target height of the camera for the target pixel based on the target normal vector, determining a scale factor based on the relative target height of the camera for the target pixel and an absolute height of the camera measured in advance, and determining the target distance between the camera and the point in the real world corresponding to the target pixel in the lane plane image based on the scale factor.

The determining of the scale factor may include determining a relative representative height of the camera based on the relative target height of the camera for the target pixel, and determining the scale factor based on the relative representative height of the camera and the absolute height of the camera.

The determining of the target distance between the camera and the point in the real world corresponding to the target pixel in the lane plane image based on the scale factor may include determining the target distance between the camera and the point in the real world corresponding to the target pixel based on the scale factor and a target pixel value of a target depth pixel in the depth map corresponding to the target pixel.

The distance determination method may further include visualizing and outputting, to a user, the determined target distance between the camera and the point in the real world corresponding to the target pixel in the lane plane image.

According to an aspect, there is provided a distance determination device including at least one processor, and a memory configured to store instructions, wherein the processor, when the instructions are executed, may be configured to perform generating a target image using a camera, generating a lane plane image based on the target image, generating a depth map based on the target image, and determining a target distance between the camera and a point in a real world corresponding to a target pixel in the lane plane image based on the lane plane image and the depth map.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1A illustrates a capturing device and a vehicle according to an example;

FIG. 1B illustrates a target image according to an example;

FIG. 1C illustrates a depth map generated based on a target image according to an example;

FIG. 2 illustrates a controller of a distance determination device according to an embodiment;

FIG. 3 is a flowchart illustrating a distance determination method according to an embodiment;

FIG. 4 is a flowchart illustrating an operation of generating a lane plan image according to an embodiment;

FIG. 5 is a flowchart illustrating an operation of generating a first image according to an embodiment;

FIG. 6A illustrates a vanishing point and a vanishing line for a target image;

FIG. 6B illustrates a first image generated based on a region of interest;

FIG. 7 is a flowchart illustrating an operation of generating a second image according to an embodiment;

FIG. 8 illustrates a second image generated based on a first image according to an example;

FIG. 9 is a flowchart illustrating an operation of generating a third image according to an embodiment;

FIG. 10 illustrates a third image generated based on a second image according to an example;

FIG. 11 is a flowchart illustrating an operation of generating a lane plane image according to an embodiment;

FIG. 12 illustrates a lane plane image generated based on a third image according to an example;

FIG. 13A is a flowchart illustrating an operation of determining a target distance between a camera and a point in the real world corresponding to a target pixel in a lane plane image according to an embodiment;

FIG. 13B illustrates a method of determining a target normal vector for a target pixel in a lane plane image;

FIG. 14 is a flowchart illustrating an operation of determining a scale factor according to an embodiment; and

FIG. 15 is a diagram illustrating an operation of determining a relative representative height of a camera based on a relative target height of the camera for a target pixel in a lane plane image according to an example.

### DETAILED DESCRIPTION

The following detailed structural or functional description is provided as an example only and various alterations and modifications may be made to the embodiments. Here, the embodiments are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical or scientific terms have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like components, and any repeated description related thereto will be omitted.

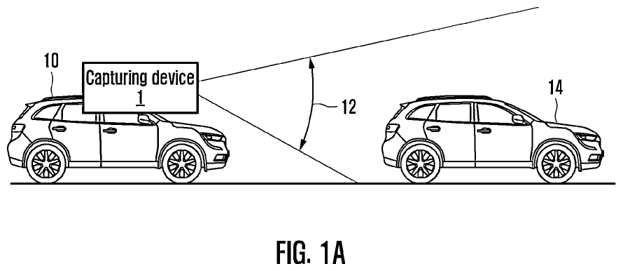

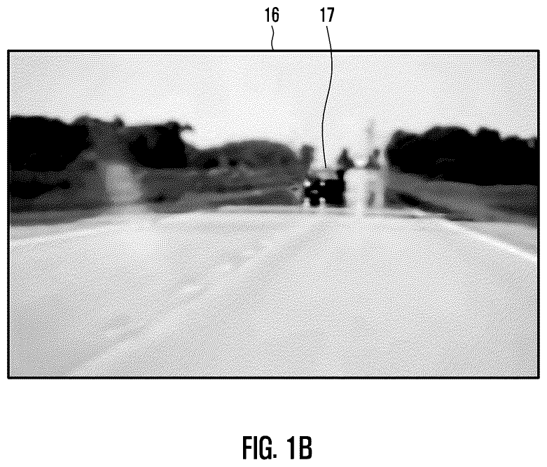

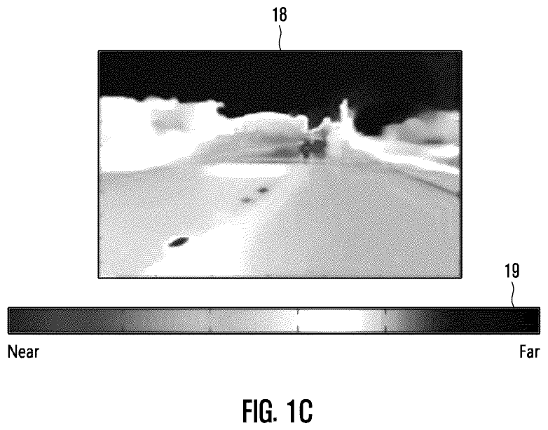

FIG. 1A illustrates a capturing device and a vehicle according to an example.

Referring to FIG. 1A, a first vehicle 10 may include a capturing device 1 for capturing a view in front of the first vehicle 10. The capturing device 1 may be an electronic device for performing a distance determination method. The capturing device 1 may correspond to an electronic device that uses the distance determination method or may include an electronic device that uses the distance determination method. For example, the capturing device 1 may be a black box for a vehicle that includes a camera. A target image may be generated using the capturing device 1. The target image may be an image acquired by capturing the view in front of the first vehicle 10. The target image may include an image of an object (e.g., a second vehicle 14) positioned in front of the first vehicle 10.

In an example, the capturing device 1 may generate the target image for a predetermined time t. The capturing device 1 may extract a road region in the target image using a vanishing point in the target image.

Although FIG. 1A shows that the first vehicle 10 includes the capturing device 1 and that the distance determination method is performed by the capturing device 1, the device, method, and relationship between the devices for performing the distance determination method are not limited to the described embodiment.

FIG. 1B illustrates a target image according to an example.

According to an embodiment, the capturing device 1 may generate a target image 16. The target image 16 may be an image for a predetermined time t. The target image 16 may be an image acquired by capturing a view in front of a vehicle (e.g., the first vehicle 10 of FIG. 1A). The target image 16 may include the shape 17 of an object (e.g., the second vehicle 14 of FIG. 1A) positioned in front of the vehicle.

FIG. 1C illustrates a depth map generated based on a target image according to an example.

According to an embodiment, the capturing device 1 may generate a depth map 18 using the target image 16. For example, the capturing device 1 may generate the depth map 18 for the target image 16 using a pre-trained depth map generation model. The depth map 18 may represent depth information 19 about pixels in the target image 16. For example, the depth information 19 may represent the relative distances between pixels in the depth map 18 according to the values (e.g., the brightness and darkness) of the pixels. The method by which the depth map 18 represents the depth information 19 is not limited to the described embodiment.

In an example, the pre-trained depth map generation model may be a neural network-based model or algorithm. For example, the depth map generation model may be a model based on a convolutional neural network (CNN), a deep neural network (DNN), or a recurrent neural network (RNN), and the type of the depth map generation model is not limited to the described embodiment.

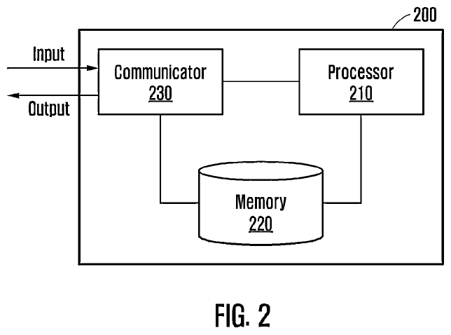

FIG. 2 illustrates a controller of a distance determination device according to an embodiment.

Referring to FIG. 2, a controller 200 of a distance determination device (e.g., the capturing device 1 of FIG. 1A) may include at least one processor 210, a memory 220 configured to store instructions, and a communicator 230.

The processor 210 may process data received by the communicator 230 and data stored in the memory 220. The “processor” may be a hardware-implemented data processing device having a physically structured circuit to execute desired operations. The desired operations may include, for example, code or instructions included in a program. The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 210 may execute computer-readable code (e.g., software) stored in a memory (e.g., the memory 220) and instructions triggered by the processor 210.

The memory 220 may store the data received by the communicator 230 and the data processed by the processor 210. For example, the memory 220 may store a program (or application, or software). The stored program may be a set of syntaxes that are coded and executable by the processor 210 to control the controller 200 of the distance determination device.

In an example, the memory 220 may include at least one volatile memory, nonvolatile memory, random-access memory (RAM), flash memory, a hard disk drive, and an optical disc drive.

The memory 220 may store an instruction set (e.g., software) to operate the controller 200 of the distance determination device. The instruction set to operate the controller 200 of the distance determination device may be executed by the processor 210.

The communicator 230 may be connected to the processor 210 and the memory 220 and transmit and receive data to and from the processor 210 and the memory 220. The communicator 230 may be connected to another external device (e.g., the first vehicle 10 of FIG. 1A) and transmit and receive data to and from the external device. Hereinafter, transmitting and receiving “A” may refer to transmitting and receiving “information or data indicating A”.

The communicator 230 may be implemented as circuitry in the controller 200 of the distance determination device. For example, the communicator 230 may include an internal bus and an external bus. As another example, the communicator 230 may be an element connecting the distance determination device (or the controller 200 of the distance determination device) and an external device. The communicator 230 may be an interface. The communicator 230 may receive data from the external device and transmit the data to the processor 210 and the memory 220.

The processor 210 may be configured to perform, when the instructions are executed, generating a target image using a camera, generating a lane plane image based on the target image, generating a depth map based on the target image, and determining a target distance between the camera and a point in the real world corresponding to a target pixel in the lane plane image based on the lane plane image and the depth map.

In an example, the generating of the lane plane image may include generating a first image in which a region of interest is set, based on the target image, generating a second image in which line segments are extracted, based on the first image, generating a third image in which lane lines are extracted, based on the second image, and generating the lane plane image, based on the third image.

In an example, the generating of the first image may include setting a vanishing point for the target image, and extracting the region of interest based on the vanishing point.

In an example, the generating of the second image may include separating line segments for the region of interest in the first image, and extracting the separated line segments.

In an example, the line segments may be separated based on edges of objects included in the region of interest.

In an example, the line segments may be separated based on the degree of changes in brightness values of pixels included in the region of interest.

In an example, the generating of the third image may include separating lane lines for the line segments in the second image, and extracting the separated lane lines.

In an example, the lane lines may be separated based on the angles of lines included in the line segments, the lengths of the lines included in the line segments, or the distances from a vanishing point to the lines included in the line segments.

In an example, the generating of the lane plane image based on the third image may include determining a lane region based on the lane lines in the third image, and generating the lane plane image based on the determined lane region.

In an example, the lane region may be determined based on coordinate values of pixels included in the lane lines.

In an example, the generating of the depth map may include generating a depth map for the target image using a pre-trained depth map generation model.

In an example, the determining of the target distance may include determining a target pixel in the lane plane image, determining a target normal vector for the target pixel in the lane plane image, determining a relative target height of the camera for the target pixel based on the target normal vector, determining a scale factor based on the relative target height of the camera for the target pixel and an absolute height of the camera measured in advance, and determining the target distance between the camera and the point in the real world corresponding to the target pixel in the lane plane image based on the scale factor.

In an example, the determining of the scale factor may include determining a relative representative height of the camera based on the relative target height of the camera for the target pixel, and determining the scale factor based on the relative representative height of the camera and the absolute height of the camera.

In an example, the determining of the target distance between the camera and the point in the real world corresponding to the target pixel in the lane plane image based on the scale factor may include determining the target distance between the camera and the point in the real world corresponding to the target pixel based on the scale factor and a target pixel value of a target depth pixel in the depth map corresponding to the target pixel.

In an example, the processor 210 may be further configured to perform visualizing and outputting, to a user, the determined target distance between the camera and the point in the real world corresponding to the target pixel in the lane plane image.

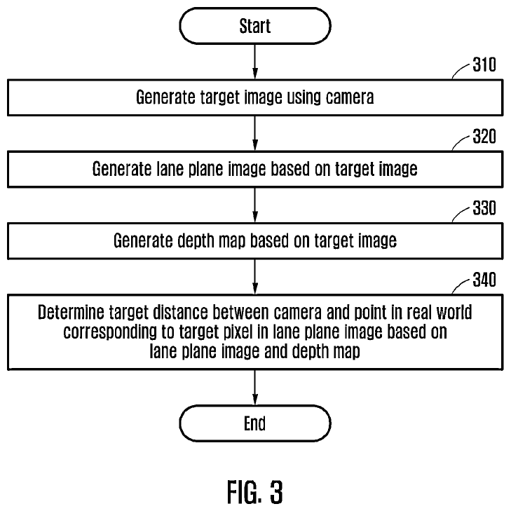

FIG. 3 is a flowchart illustrating a distance determination method according to various embodiments.

Operations 310 to 340 may be performed by the controller (e.g., the controller 200 of FIG. 2) of the distance determination device described above with reference to FIG. 2.

In operation 310, the controller of the distance determination device may generate a target image using a camera. In an example, the distance determination device may further include the camera or be connected to the camera. In an example, a target image (e.g., the target image 16 of FIG. 1B) may be an image acquired by capturing a view in front of a vehicle (e.g., the first vehicle 10 of FIG. 1A).

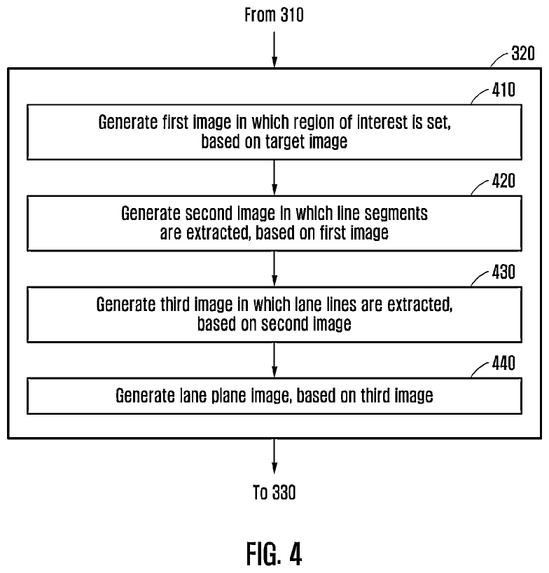

In operation 320, the controller of the distance determination device may generate a lane plane image based on the target image. In an example, the lane plane image may be an image acquired by extracting a lane region from the target image. A method of generating the lane plane image based on the target image will be described below in further detail with reference to FIGS. 4 to 12.

In operation 330, the controller of the distance determination device may generate a depth map (e.g., the depth map 18 of FIG. 1C) based on the target image. In an example, the depth map may represent depth information of the target image.

According to an embodiment, the controller of the distance determination device may generate the depth map for the target image using a pre-trained depth map generation model.

Although FIG. 3 shows that operation 330 is performed after operation 320, the order of operation 320 and operation 330 is not limited to the described embodiment. For example, operation 320 and operation 330 may be performed in parallel or separately.

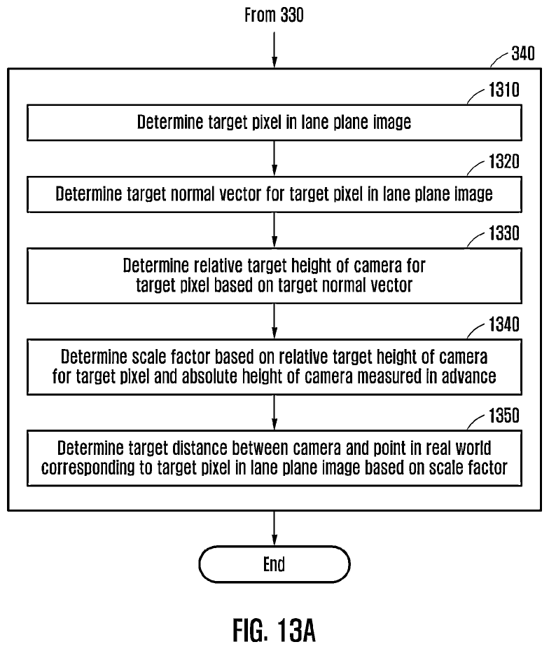

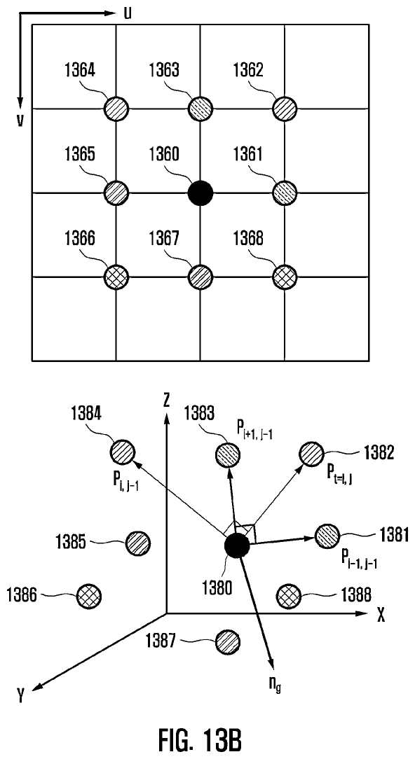

In operation 340, the controller of the distance determination device may determine a target distance between the camera and a point in the real world corresponding to a target pixel in the lane plane image based on the lane plane image and the depth map. In an example, the target pixel which is one of predetermined pixels on the lane plane image may correspond to a predetermined point in the real world corresponding to the lane plane image. The target distance may be the actual distance from the camera to the predetermined point in the real world. For example, the actual distance may be based on the metric system. The controller of the distance determination device may determine the target distance between the camera and the predetermined point in the real world based on the lane plane image and the depth map. A method of determining the target distance between the camera and the predetermined point in the real world based on the lane plane image and the depth map will be described below in further detail with reference to FIGS. 13A to 15.

In an embodiment, visualizing and outputting, to a user, the determined target distance may be further performed after operation 340. For example, the distance determination device may visualize the determined target distance through a device such as a navigation system or a head-up display. The user may intuitively verify the distance information about an object positioned in front of the vehicle through the visualized distance to the object. The user may instantly predict or recognize many dangerous situations (e.g., head-on collision, rear-end collision, etc.) through the distance information and drive more safely.

FIG. 4 is a flowchart illustrating an operation of generating a lane plan image according to an embodiment.

In an embodiment, operation 320 of FIG. 3 may include operations 410 to 440. Operations 410 to 440 may be performed by the controller (e.g., the controller 200 of FIG. 2) of the distance determination device described above with reference to FIG. 2.

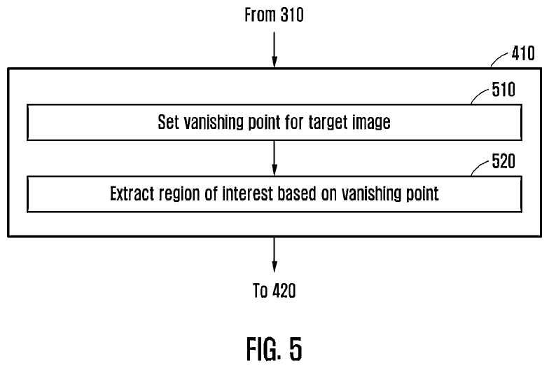

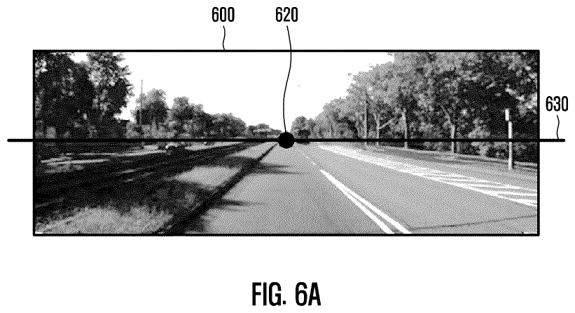

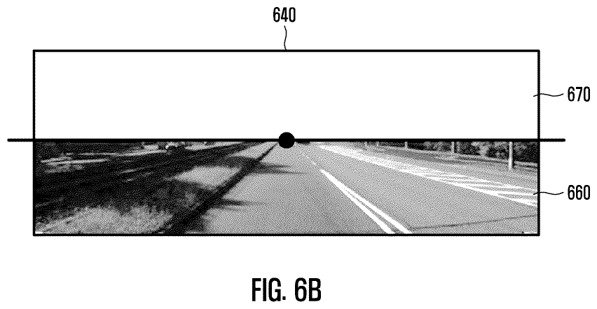

In operation 410, the controller of the distance determination device may generate a first image in which a region of interest is set, based on the target image. In an example, the target image may include the shapes of multiple objects positioned in front of the vehicle. When the region of interest is set in the target image, only the information necessary to estimate a depth map for a view in front of the vehicle may be used efficiently. An operation of generating the first image based on the target image will be described below in further detail with reference to FIGS. 5 to 6B.

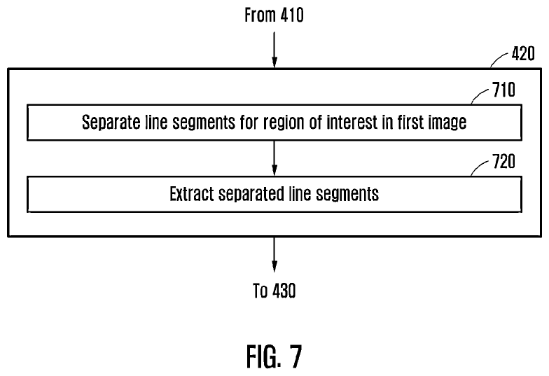

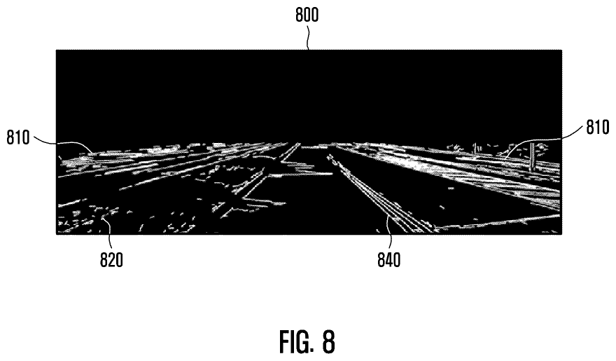

In operation 420, the controller of the distance determination device may generate a second image in which line segments are extracted, based on the first image. In an example, the first image may include the shapes of multiple objects positioned in the set region of interest. When the line segments are extracted from the first image, edge lines between the objects included in the first image may be obtained. An operation of generating the second image based on the first image will be described below in further detail with reference to FIGS. 7 and 8.

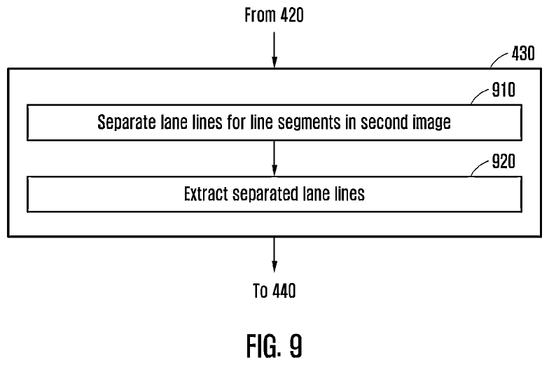

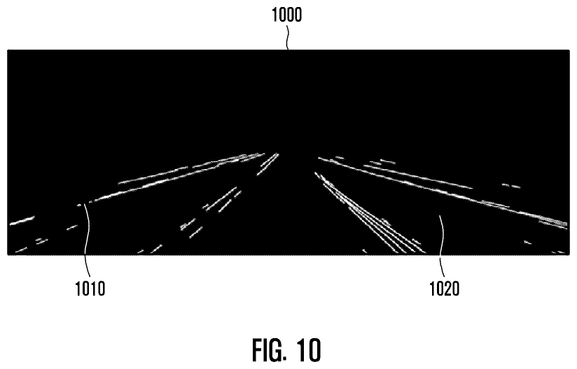

In operation 430, the controller of the distance determination device may generate a third image in which lane lines are extracted, based on the second image. In an example, the second image may include edge lines between multiple objects. When lane lines are extracted from the second image, only edge lines of lanes positioned in front of a vehicle may be acquired. An operation of generating the third image based on the second image will be described below in further detail with reference to FIGS. 9 and 10.

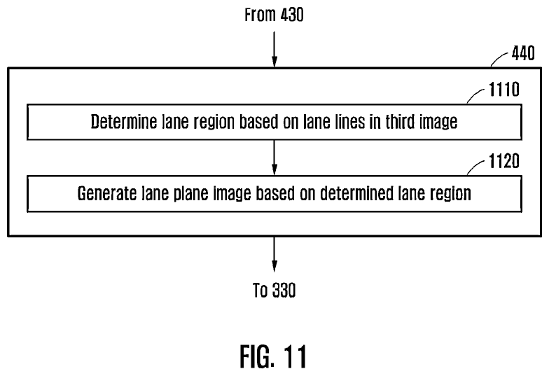

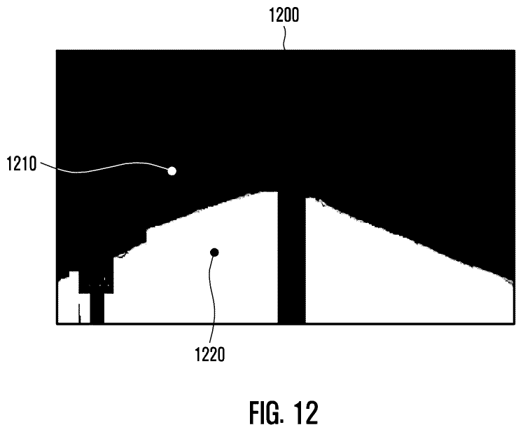

In operation 440, the controller of the distance determination device may generate the lane plane image, based on the third image. In an example, the third image may include edge lines of lanes. When a lane region is distinguished in the third image, only a road region positioned in front of the vehicle may be acquired. An operation of generating the lane plane image based on the third image will be described below in further detail with reference to FIGS. 11 and 12.

Although FIG. 4 shows that operation 330 is performed after operation 440 (or operation 320), the order of operation 320 and operation 330 is not limited to the described embodiment. For example, operation 320 and operation 330 may be performed in parallel or separately.

FIG. 5 is a flowchart illustrating an operation of generating a first image according to an embodiment.

In an embodiment, operation 410 of FIG. 4 may include operations 510 and 520. Operations 510 and 520 may be performed by the controller (e.g., the controller 200 of FIG. 2) of the distance determination device described above with reference to FIG. 2.

In operation 510, the controller of the distance determination device may set a vanishing point for the target image. In an example, a vanishing point for an optical axis of the camera or a vanishing point for the target image may correspond to the principal point of the target image. The vanishing point for the optical axis of the camera or the vanishing point for the target image may be set based on the principal point of the target image.

In operation 520, the controller of the distance determination device may extract the region of interest based on the vanishing point. In an example, the controller of the distance determination device may set a vanishing line for the target image based on the vanishing point. The vanishing line may correspond to the horizon positioned in front of the vehicle (e.g., the first vehicle 10 of FIG. 1A). The vanishing line may correspond to the edge of the road region positioned in front of the vehicle. In an example, a region below the vanishing line drawn based on the vanishing point may be set as the region of interest. The region of interest may correspond to the road region positioned in front of the vehicle.

FIG. 6A illustrates a vanishing point and a vanishing line for a target image.

Referring to FIG. 6A, a target image 600, a vanishing point 620, and a vanishing line 630 are shown.

According to an embodiment, the vanishing point 620 for the target image 600 may be set based on the principal point of the target image 600.

According to an embodiment, the vanishing line 630 for the target image 600 may be set based on the vanishing point 620 of the target image 600. A region below the vanishing line 630 may be set as a region of interest. Based on the set region of interest, the region of interest may be extracted from the target image 600.

FIG. 6B illustrates a first image generated based on a region of interest.

Referring to FIG. 6B, a first image 640 and a region of interest 660 are shown. According to an embodiment, only a region positioned below the vanishing line 630 may be extracted as the region of interest 660. The region of interest 660 may be determined based on the whole region of the target image.

FIG. 7 is a flowchart illustrating an operation of generating a second image according to an embodiment.

In an embodiment, operation 420 of FIG. 4 may include operations 710 and 720. Operations 710 and 720 may be performed by the controller (e.g., the controller 200 of FIG. 2) of the distance determination device described above with reference to FIG. 2.

In operation 710, the controller of the distance determination device may separate line segments for the region of interest (e.g., the region of interest 660 of FIG. 6B) in the first image (e.g., the first image 640 of FIG. 6B). In an example, the region of interest 660 described above with reference to FIG. 6B may include the shapes of multiple objects. For example, the multiple objects may include a road, lanes, other vehicles positioned in front, or shadows.

In an embodiment, before extracting lane lines forming the edges of the road and the lane, line segments forming the edges of multiple objects may be separated. Aline segment may include a line segment forming the edge of an object.

In an embodiment, the controller of the distance determination device may separate the line segments based on the edges of the objects included in the region of interest. In an embodiment, the controller of the distance determination device may separate the line segments based on the degree of changes in brightness values of pixels included in the region of interest. A method of separating the line segments based on the region of interest is not limited to the described embodiment.

In operation 720, the controller of the distance determination device may extract the separated line segments. The controller of the distance determination device may extract the separated line segments and generate the second image based on the line segments. The second image may include the line segments forming the edges of the multiple objects included in the region of interest 660 described above with reference to FIG. 6B.

According to an embodiment, the Canny Edge Detector algorithm may be used to generate the second image. The Canny Edge Detector algorithm may include a noise removal operation using a Gaussian filter, a gradient calculation operation to apply variables x and y to an image, a non-maximum suppression (NMS) operation to leave only sharp edges, a double thresholding operation to determine the strength of edges, and an edge tracking operation to keep only strong edges. A method of generating the second image in which line segments are extracted based on the first image is not limited to the described embodiment.

FIG. 8 illustrates a second image generated based on a first image according to an example.

Referring to FIG. 8, a second image 800, a first line segment 810, a second line segment 820, and a third line segment 840 are shown.

The region of interest 660 described above with reference to FIG. 6B may include the shapes of multiple objects. For example, the region of interest 660 may include a road, lanes, street trees, and shadows. Line segments of the multiple objects included in the region of interest 660 may be separated through operation 710 described above with reference to FIG. 7.

Through operation 720 described above with reference to FIG. 7, the separated line segments may be extracted, and the second image 800 may be generated based on the line segments. The second image 800 may include line segments forming the edges of multiple objects. For example, the first line segment 810 may include line segments of street trees positioned in a region other than the road. The second line segment 820 may include line segments of the shadows of the street trees. The third line segment 840 may include line segments of the lanes positioned in the road region. The types and configurations of the line segments included in the second image 800 are not limited to the described embodiment.

FIG. 9 is a flowchart illustrating an operation of generating a third image according to an embodiment.

In an embodiment, operation 430 of FIG. 4 may include operations 910 and 920. Operations 910 and 920 may be performed by the controller (e.g., the controller 200 of FIG. 2) of the distance determination device described above with reference to FIG. 2.

In operation 910, the controller of the distance determination device may separate lane lines for the line segments in the second image. In an example, the second image 800 described above with reference to FIG. 8 may include line segments of multiple objects. For example, the second image 800 may include the first line segment 810, the second line segment 820, and the third line segment 840. In an embodiment, before extracting a road region forming the road surface, lane lines forming the edges of the road and the lane may be separated. The lane lines may include line segments forming the edges of the road and the lane. In an embodiment, the lane lines may be separated based on the angles of lines included in the line segments. For example, the gradient values of the lines may be calculated, and lines within a predetermined angle range (e.g., a range of 30 degrees to 150 degrees based on the vanishing line) may be separated. In an embodiment, the lane lines may be separated based on the lengths of lines included in the line segments. For example, the length values of the lines may be calculated, and lines within a predetermined length range (e.g., the length range of the top 90% based on the longest length) may be separated. In an embodiment, the lane lines may be separated based on the distances from the vanishing point to the lines included in the line segments. For example, the distance values from the vanishing point to the lines may be calculated, and lines within a predetermined distance range (e.g., the distance range of the top 90& based on the shortest distance) may be separated. Operations and methods of separating the lane lines based on the line segments are not limited to the described embodiment.

In operation 920, the controller of the distance determination device may extract the separated lane lines. In an example, the controller of the distance determination device may extract the separated lane lines and generate the third image based on the lane lines. The third image may include lane lines forming the edges of the road and the lane included in the second image 800 described above with reference to FIG. 8.

FIG. 10 illustrates a third image generated based on a second image according to an example.

Referring to FIG. 10, a third image 1000, a lane line 1010, and a road region 1020 are shown. The second image 800 described above with reference to FIG. 8 may include line segments of multiple objects. For example, the second image 800 may include the first line segment 810, the second line segment 820, and the third line segment 840.

Through operation 910 described above with reference to FIG. 9, lane lines for multiple line segments included in the second image 800 may be separated. For example, during the process of separating lines within a predetermined angle range (e.g., 30 degrees to 150 degrees) based on the angles of lines included in the line segments, the first line segment 810 may be excluded. For example, during the process of separating lines within a predetermined length range (e.g., the length range of the top 90% based on the longest length) based on the lengths of lines included in the line segments, the second line segment 820 may be excluded. For example, the process of separating lines based on the distances from the vanishing point to the lines included in the line segments may be further performed.

Through operation 920 described above with reference to FIG. 9, the separated lane lines may be extracted, and the third image 1000 may be generated based on the lane lines. The third image 1000 may include the lane line 1010 forming the edges of the road and the lane and the road region 1020 positioned below the lane line 1010.

FIG. 11 is a flowchart illustrating an operation of generating a lane plane image according to an embodiment.

In an embodiment, operation 440 of FIG. 4 may include operations 1110 and 1120. Operations 1110 and 1120 may be performed by the controller (e.g., the controller 200 of FIG. 2) of the distance determination device described above with reference to FIG. 2.

In operation 1110, the controller of the distance determination device may determine a lane region based on the lane lines in the third image. In an example, the third image 1000 described above with reference to FIG. 10 may include a lane line (e.g., the lane line 1010 of FIG. 10) forming the edges of the road and the lane. In an embodiment, the lane region may be determined based on the coordinate values of pixels included in the lane lines. For example, coordinate values such as first coordinates (x1, y1), second coordinates (x2, y2), . . . , and n-th coordinates (xn, yn) may be set for predetermined pixels included in the lane lines. By comparing the y-coordinate values of the coordinates with the same x-coordinate values, the uppermost coordinates (e.g., the coordinates with the largest y-coordinate value) may be determined. In the third image 1000, a road region and a region other than the road may be determined based on pixels included in the uppermost lane line. The lane region may be determined based on the determined road region and region other than the road. The lane region may correspond to the road positioned in front of a moving vehicle (e.g., the first vehicle 10 of FIG. 1A).

In operation 1120, the controller of the distance determination device may generate the lane plane image based on the determined lane region. In an example, a region below the determined lane region may correspond to the road positioned in front of the moving vehicle (e.g., the first vehicle 10 of FIG. 1A). A region above the determined lane region may correspond to the region other than the road positioned in front of the moving vehicle. In an example, an information value of “1” may be assigned to pixels positioned in the region below the determined lane region, and an information value of “1” may be assigned to pixels positioned in the region above the determined lane region. Based on the different information values, different color values (e.g., white, black, etc.) may be assigned to predetermined pixels on the third image 1000. Based on different information values or different color values, whether predetermined pixels on the third image 1000 correspond to the lane region may be determined. Information values or color values to be assigned to pixels may depend on settings, and are not limited to the described embodiment.

Although FIG. 11 illustrates that operation 330 is performed after operation 1120, the order of operation 320 and operation 330 including operation 1120 (or operation 440) is not limited to the described embodiment. For example, operation 320 and operation 330 may be performed in parallel or separately.

FIG. 12 illustrates a lane plane image generated based on a third image according to an example.

Referring to FIG. 12, a lane plane image 1200, a lane region, and a region other than the lane are shown. The third image 1000 described above with reference to FIG. 10 may include lane lines forming the edges of a road and a lane.

Through operation 1110 described above with reference to FIG. 11, the lane region may be determined based on the lane lines included in the third image 1000. For example, in the third image 1000, pixels included in a lane line with the largest y-coordinate value based on the same x-coordinate may be determined. Based on the determined pixels, a road region and the region other than the road may be determined. Based on the determined road region and region other than the road, the lane region may be determined.

Through operation 1120 described above with reference to FIG. 11, the lane plane image 1200 may be generated based on the determined lane region. In the lane plane image 1200, the lane region (e.g., a region including a target pixel 1220) may correspond to the road positioned in front of a moving vehicle, based on the determined lane region. For example, an information value of “1” may be assigned to pixels positioned in the lane region. For example, a color value to be expressed in white may be assigned to the pixels positioned in the lane region. In the lane plane image 1200, the region other than the lane (e.g., a region including a pixel 1210) may correspond to the region other than the road positioned in front of the moving vehicle, based on the determined lane region. For example, an information value of “0” may be assigned to pixels positioned in the region other than the lane. For example, a color value to be expressed in black may be assigned to the pixels positioned in the region other than the lane.

FIG. 13A is a flowchart illustrating an operation of determining a target distance between a camera and a point in the real world corresponding to a target pixel in a lane plane image according to an embodiment.

FIG. 13B illustrates a method of determining a target normal vector for a target pixel in a lane plane image.

In an embodiment, operation 340 of FIG. 3 may include operations 1310 to 1350. Operations 1310 to 1350 may be performed by the controller (e.g., the controller 200 of FIG. 2) of the distance determination device described above with reference to FIG. 2.

In operation 1310, the controller of the distance determination device may determine a target pixel in the lane plane image. In an example, the lane plane image 1200 described above with reference to FIG. 12 may include multiple target pixels. A target pixel may be a predetermined pixel (or point) included in the lane region of the lane plane image 1200. For example, the target pixel 1220 may be a pixel P_{i,j} with coordinate values (i, j). The controller of the distance determination device may determine a predetermined pixel included in the lane region of the lane plane image. The determined target pixel 1220 may correspond to a determined target pixel 1360 in a two-dimensional (2D) space or a determined target point 1380 in a 3D space of FIG. 13B.

In operation 1320, the controller of the distance determination device may determine a target normal vector for the target pixel in the lane plane image. In an example, surrounding pixel pairs centered around the determined target pixel may be set. For example, the surrounding pixel pairs may be pixel pairs that are positioned adjacent to the target pixel and form 90 degrees with respect to the target pixel. For example, four surrounding pixels may be set in four directions (upward, downward, leftward, and rightward) with respect to the target pixel.

For example, surrounding pixels 1361 to 1368 in the 2D space may be set around the determined target pixel 1360 in the 2D space of FIG. 13B. Based on the surrounding pixels 1361 to 1368, a first surrounding pixel pair of pixels 1361 and 1363, a second surrounding pixel pair of pixels 1362 and 1364, a third surrounding pixel pair of pixels 1365 and 1367, and a fourth surrounding pixel pair of pixels 1366 and 1368 may be set.

For example, surrounding points 1381 to 1388 in the 3D space centered around the target point 1380 in the 3D space of FIG. 13B may be set. The target pixel 1360 and the surrounding pixels 1361 to 1368 in the 2D space may correspond to the target point 1380 and the surrounding points 1381 to 1388 in the 3D space, respectively. Arranging the target pixel 1360 and the surrounding pixels 1361 to 1368 in the 2D space on the 3D space, the pixel 1360 and the surrounding pixels 1361 to 1368 may correspond to the target point 1380 and the surrounding points 1381 to 1388.

A first surrounding point pair of surrounding points 1381 and 1383, a second surrounding point pair of points 1382 and 1384, a third surrounding point pair of points 1385 and 1387, and a fourth surrounding point pair of points 1386 and 1388 may be set. The points of each surrounding point pair may form an angle of 90 degrees with respect to the target point 1380.

Based on the four surrounding pixel pairs, a first normal vector, a second normal vector, a third normal vector, and a fourth normal vector for the target pixel may be determined. The target normal vector may be determined based on the first to fourth normal vectors. For example, the target normal vector may be the average value of the first to fourth normal vectors.

In an example, the process of determining the target normal vector may be expressed by the pseudo-code in the following [Table 1]. In the pseudo-code, RP denotes the lane plane image, P_{i,j} denotes the target pixel, and N(P_{i,j}) denotes the target normal vector for the target pixel. For example, the target pixel 1220 described above with reference to FIG. 12, the determined target pixel 1360 in the 2D space, or the determined target pixel 1380 in the 3D space of FIG. 13B may correspond to P_{i,j}. Based on the pseudo-code, a target normal vector N(P_{i,j}) for the target pixel may be determined.

A method of determining the target normal vector for the target pixel is not limited to the described embodiment.

```
TABLE 1
Procedure RoadPlane(RP)
  set RP
  for lᵢ to N:
  for P_{i,j} ∈ lᵢ to height:
  set G(P_{i,j}); is two points in one pair form a 90-degree angle;
    G(P_{i,j}) = {[P_{i+1,j}, P_{i,j-1}], [P_{i+1,j-1}, P_{i-1,j-1}], ... }
G_{a,b} denotes the b-th element of the a-th pair in G(P_{i,j}) and g = 1,2,3,4.
  $RP ( {P}_{i , j} ) = N ( G ( {P}_{( i , j )} ) ) = \frac{{\sum }_{g} n / {‖ {n}_{g} ‖}_{2}}{4} cf {.}^{{n}_{g} = \vec{{P}_{i , j} {G}_{g , 1}} \times \vec{{P}_{i , j} {G}_{g , 2}}}$
```

In operation 1330, the controller of the distance determination device may determine a relative target height of the camera for the target pixel based on the target normal vector. In an example, the target pixel 1220 in the lane plane image 1200 described above with reference to FIG. 12 may include the coordinates of the pixel, the information value (e.g., the information value of “1”) to determine whether the pixel corresponds to the lane region, and the target normal vector information.

In an example, the coordinates of the target pixel 1220 positioned in the lane plane image 1200 may be projected to point coordinates within the real world corresponding to the target pixel based on the depth map. In [Equation 1] below, Dₜ denotes a coefficient determined based on the depth map, K denotes an intrinsic parameter coefficient of a previously known capturing device (e.g., camera) (camera intrinsic matrix), and p_{i,j}=[i,j,1]^{T} and P_{i,j}=[X,Y,Z]^{T} may be expressed.

$${D}_{t} ( {p}_{i , j} ) {p}_{i , j} = K {P}_{i , j} \qquad [ Equation 1 ]$$

In an example, the point coordinates of the capturing device may be determined to be the origin. The vector from the capturing device to the point coordinates within the real world corresponding to the target pixel may be expressed as in [Equation 2] below.

$$\vec{{OP}_{i , j}} = {P}_{i , j} = {[ X , Y , Z ]}^{T} \qquad [ Equation 2 ]$$

In an example, the target normal vector N(P_{i,j}) for the target pixel may correspond to the vector N(P_{i,j})^{T} from the point coordinates within the real world corresponding to the target pixel toward the ground within the real world. Based on the dot product of \vec{OP_{i,j}} and N(P_{i,j})^{T}, a relative target height of the capturing device for the target pixel may be determined. The relative target height of the capturing device for the target pixel may be expressed as in [Equation 3] below.

$$h ( {P}_{i , j} ) = {N ( {P}_{i , j} )}^{T} \cdot \vec{{OP}_{i , j}} \qquad [ Equation 3 ]$$

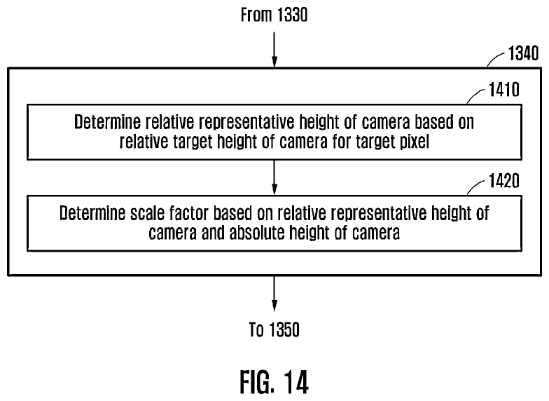

In operation 1340, the controller of the distance determination device may determine a scale factor based on the relative target height of the capturing device for the target pixel and the absolute height of the capturing device measured in advance. In an example, through operation 1410 described later with reference to FIG. 14, the relative representative height of the capturing device may be determined based on the relative target height of the capturing device for the target pixel. For example, the relative representative height of the capturing device may be the average value of all relative target heights of the capturing device for all target pixels corresponding to the lane region of the lane plane image 1200. The relative representative height of the capturing device may be expressed as in [Equation 4] below.

$${h}_{M} = Median ( {h}_{1} , {h}_{2} , {h}_{3} … ) \qquad [ Equation 4 ]$$

In an example, the absolute height h_{R} of the capturing device within the real world may be measured in advance. A scale factor S may be determined based on the relative target height h_{M} of the capturing device and the absolute height h_{R} of the capturing device measured in advance. The scale factor may be expressed as in [Equation 5] below.

$$S = \frac{{h}_{R}}{{h}_{M}} \qquad [ Equation 5 ]$$

In operation 1350, the controller of the distance determination device may determine the target distance between the capturing device and the point in the real world corresponding to the target pixel in the lane plane image based on the scale factor. In an embodiment, operation 1350 may further include determining the target distance between the capturing device and the point in the real world corresponding to the target pixel based on the scale factor and a target pixel value of a target depth pixel in the depth map corresponding to the target pixel.

The target distance Dₜ^{abs} between the capturing device and the point within the real world corresponding to the target pixel may be expressed as in [Equation 6] below. In [Equation 6], Dₜ^{rel} may be the relative distance determined based on the depth map, that is, the target pixel value of the target depth pixel in the depth map corresponding to the target pixel. Dₜ^{abs} may be the absolute distance between the capturing device and the point in the real world determined based on the scale factor.

$${D}_{t}^{a b s} = S {D}_{t}^{r e l} \qquad [ Equation 6 ]$$

FIG. 14 is a flowchart illustrating an operation of determining a scale factor according to an embodiment.

In an embodiment, operation 1340 of FIG. 13A may include operations 1410 and 1420. Operations 1410 and 1420 may be performed by the controller (e.g., the controller 200 of FIG. 2) of the distance determination device described above with reference to FIG. 2.

In operation 1410, the controller of the distance determination device may determine a relative representative height of the camera based on the relative target height of the camera for the target pixel. For example, the relative representative height h_{M} of the capturing device may be the average value of all relative target heights (h₁, h₂, h₃ . . . ) of the capturing device for all target pixels corresponding to the lane region of the lane plane image 1200.

In operation 1420, the controller of the distance determination device may determine the scale factor based on the relative representative height h_{M} of the camera and the absolute height h_{R} of the camera.

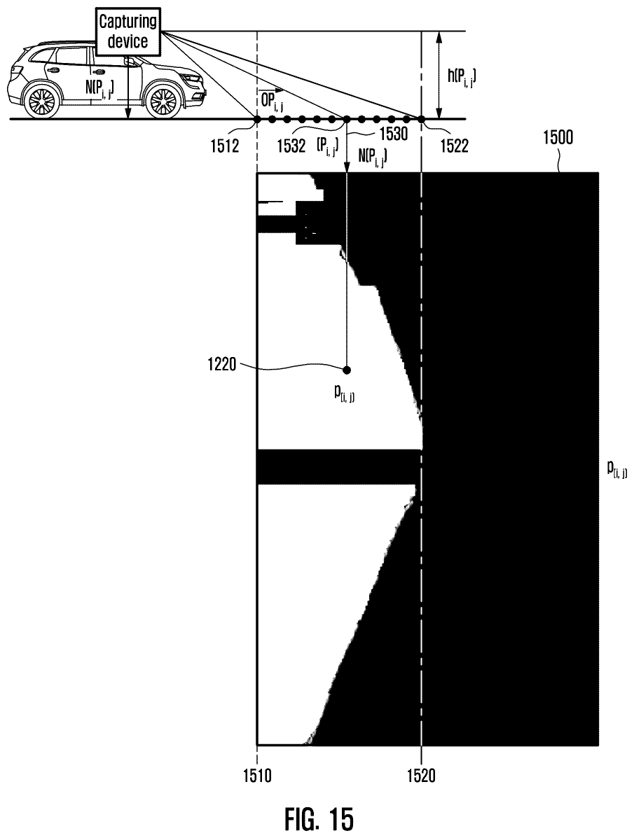

FIG. 15 is a diagram illustrating an operation of determining a relative representative height of a camera based on a relative target height of the camera for a target pixel in a lane plane image according to an example.

Referring to FIG. 15, a lane plane image 1500, a vehicle, a capturing device, and a road are shown. The lane plane image 1500 may include a lane region, a region other than the lane, and a vanishing point.

Through operation 1310 described above with reference to FIG. 13A, the target pixel 1220 included in the lane region of the lane plane image 1500 may be determined. The target pixel 1220 may include the coordinates of the pixel and an information value (e.g., an information value of “1”) to determine whether the pixel corresponds to the lane region.

Through operation 1320 described above with reference to FIG. 13A, the target normal vector for the target pixel 1220 may be determined. The target pixel 1220 may include information about the determined target normal vector N(P_{i,j}).

Through operation 1330 described above with reference to FIG. 13A, the relative height of the camera for the target pixel 1220 may be determined based on the target normal vector. In an example, a lowest region 1510 of the lane plane image 1500 may correspond to the lowest region in the field of view of the capturing device in the real world. The lowest region in the field of view of the capturing device in the real world may include a predetermined pixel 1512 positioned in the lowest region. A parallel axis region 1520 including the vanishing point of the lane plane image 1500 may correspond to a parallel axis region including the horizon in the field of view of the capturing device in the real world. The parallel axis region including the horizon in the field of view of the capturing device in the real world may include a predetermined pixel 1522 positioned in the parallel axis region including the horizon.

In an example, the target pixel 1220 positioned in the lane plane image 1500 may correspond to a point 1532 in the real world. The coordinates of the target pixel 1220 may be projected to the coordinates of the point 1532 in the real world corresponding to the target pixel based on the depth map. The point coordinates of the capturing device may be determined as the origin, and a relative target height h(P_{i,j}) of the capturing device may be determined based on the target normal vector.

Through operation 1340 described above with reference to FIG. 13A, the scale factor may be determined based on the relative target height h(P_{i,j}) of the capturing device for the target pixel and the absolute height h_{R} of the capturing device measured in advance.

Through operation 1350 described above with reference to FIG. 13A, the target distance between the capturing device and the point 1532 in the real world corresponding to the target pixel in the lane plane image may be determined based on the scale factor. The target distance between the capturing device and the point 1532 in the real world may be an actual distance.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter. The above-described devices may be configured to act as one or more software modules in order to perform the operations of the above-described embodiments, or vice versa.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

A number of embodiments have been described above. Nevertheless, it should be understood that various modifications and variations may be made to these embodiments. For example, suitable results may be achieved if the described techniques are performed in a different order, and/or if components in a described system, architecture, device, or circuit are combined in a different manner, and/or replaced or supplemented by other components or their equivalents.

Accordingly, other implementations are within the scope of the following claims.

What is claimed is:

1. A distance determination method comprising:
generating a target image using a camera;
generating a lane plane image based on the target image;
generating a depth map based on the target image; and
determining a target distance between the camera and a point in a real world corresponding to a target pixel in the lane plane image based on the lane plane image and the depth map.

2. The distance determination method of claim 1, wherein the generating of the lane plane image comprises:
generating a first image in which a region of interest is set, based on the target image;
generating a second image in which line segments are extracted, based on the first image;
generating a third image in which lane lines are extracted, based on the second image; and
generating the lane plane image, based on the third image.

3. The distance determination method of claim 2, wherein the generating of the first image comprises:
setting a vanishing point for the target image; and
extracting the region of interest based on the vanishing point.

4. The distance determination method of claim 2, wherein the generating of the second image comprises:
separating line segments for the region of interest in the first image; and
extracting the separated line segments.

5. The distance determination method of claim 4, wherein the line segments are separated based on edges of objects included in the region of interest.

6. The distance determination method of claim 4, wherein the line segments are separated based on a degree of changes in brightness values of pixels included in the region of interest.

7. The distance determination method of claim 2, wherein the generating of the third image comprises:
separating lane lines for the line segments in the second image; and
extracting the separated lane lines.

8. The distance determination method of claim 7, wherein the lane lines are separated based on angles of lines included in the line segments, lengths of the lines included in the line segments, or distances from a vanishing point to the lines included in the line segments.

9. The distance determination method of claim 2, wherein the generating of the lane plane image based on the third image comprises:
determining a lane region based on the lane lines in the third image; and
generating the lane plane image based on the determined lane region.

10. The distance determination method of claim 9, wherein the lane region is determined based on coordinate values of pixels included in the lane lines.

11. The distance determination method of claim 1, wherein the generating of the depth map comprises generating a depth map for the target image using a pre-trained depth map generation model.

12. The distance determination method of claim 1, wherein the determining of the target distance comprises:
determining a target pixel in the lane plane image;
determining a target normal vector for the target pixel in the lane plane image;
determining a relative target height of the camera for the target pixel based on the target normal vector;
determining a scale factor based on the relative target height of the camera for the target pixel and an absolute height of the camera measured in advance; and
determining the target distance between the camera and the point in the real world corresponding to the target pixel in the lane plane image based on the scale factor.

13. The distance determination method of claim 12, wherein the determining of the scale factor comprises:
determining a relative representative height of the camera based on the relative target height of the camera for the target pixel; and
determining the scale factor based on the relative representative height of the camera and the absolute height of the camera.

14. The distance determination method of claim 12, wherein the determining of the target distance between the camera and the point in the real world corresponding to the target pixel in the lane plane image based on the scale factor comprises determining the target distance between the camera and the point in the real world corresponding to the target pixel based on the scale factor and a target pixel value of a target depth pixel in the depth map corresponding to the target pixel.

15. The distance determination method of claim 1, further comprising:
visualizing and outputting, to a user, the determined target distance between the camera and the point in the real world corresponding to the target pixel in the lane plane image.

16. A distance determination device comprising:
at least one processor; and
a memory configured to store instructions,
wherein the processor, when the instructions are executed, is configured to perform:
generating a target image using a camera;
generating a lane plane image based on the target image;
generating a depth map based on the target image; and
determining a target distance between the camera and a point in a real world corresponding to a target pixel in the lane plane image based on the lane plane image and the depth map.
